(19) United States
(12) Patent Application Publication
(10) Pub. No.: US 2005/0192964 A1
(43) Pub. Date: Sep. 1, 2005

(54) Communications system having distributed database architecture and related methods

(75) Inventors: David James Clarke, Redmond, WA (US); Steven J. McCarthy, Bellevue, WA (US); Michael Jack Zakharoff, Sumner, WA (US); Darren L. Gardner, Issaquah, WA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: TEAMON SYSTEMS, INC., Issaquah, WA (US)

(21) Appl. No.: 10/787,515

(22) Filed: Feb. 26, 2004

(51) Int. Cl. G06F 17/30

(52) U.S. Cl. 707/9

(57) ABSTRACT

A communications system may include a plurality of account databases each for storing information associated with different accounts, and a central database for storing location information associating each account with a respective account database. Additionally, the system may also include at least one communications device for accessing account information, and an interface device for receiving an account access request from the at least one communications device for a desired account. Moreover, the interface device may also be for retrieving account location information from the central database for the desired account, and interfacing the at least one communications device with the respective account database associated with the desired account based thereon.

### FIELD OF THE INVENTION

The present invention relates to the field of communications systems, and, more particularly, to database information storage and retrieval and related methods.

### BACKGROUND OF THE INVENTION

Computer database systems are frequently used to store important data in an organized fashion. For example, a database may be used to store information relating to a particular account or user for easy access and retrieval. Such information may include user contact or profile information, electronic mail (e-mail) messages, etc.

While databases are extremely useful for providing quick access to data, their effectiveness can potentially become diminished as the amount of data to be accessed grows. That is, for database systems in which thousands or even millions of customer records or e-emails are being stored, attempting to simultaneously store and/or access numerous records at the same time can create severe bottlenecks and, thus, diminish system performance.

One approach for addressing this problem is through the use of distributed databases. More particularly, the various account information is distributed or spread across multiple databases, which in turn spreads the access burden across the databases as well and thus reduces bottlenecks. Of course, one challenging aspect of implementing a distributed database system is keeping track of which accounts are associated with which databases. One approach for doing so is to use yet another database, i.e., a central database, that maps the various accounts to their respective account databases. One example of a distributed database system including such a centralized database is disclosed in U.S. Pat. No. 5,560,005, for example.

Despite such prior art systems, faster and more efficient approaches for accessing data distributed across numerous databases may be required in certain applications.

### SUMMARY OF THE INVENTION

In view of the foregoing background, it is therefore an object of the present invention to provide a communications system providing enhanced access to distributed account databases and related methods.

This and other objects, features, and advantages in accordance with the present invention are provided by a communications system which may include a plurality of account databases each for storing information associated with different accounts, and a central database for storing location information associating each account with a respective account database. Additionally, the system may also include at least one communications device for accessing account information, and an interface device for receiving an account access request from the at least one communications device for a desired account. Moreover, the interface device may also be for retrieving account location information from the central database for the desired account, and interfacing the at least one communications device with the respective account database associated with the desired account based thereon.

The interface device may also advantageously be for caching the account location information and using the cached account location information for subsequently interfacing the at least one communications device with the respective account database. As such, the interface device need not continually access the central database for account location information, which could lead to significant bottlenecks and system performance degradation. Further, since cached account location information is readily available when subsequent access to the desired account is requested, the respective account database may be accessed more quickly as well.

In particular, the interface device may include a caching module for caching the account location information. Furthermore, the at least one communications device may have an operating protocol associated therewith. As such, the interface device may further include at least one protocol interface module for communicating with the at least one communications device using the operating protocol. By way of example, the at least one protocol interface module may include one or more of a wireless access protocol (WAP) module, a post office protocol (POP) module, and a hypertext markup language (HTML) module. The interface device may also include a control module for interfacing the at least one protocol interface module with the central and account databases.

In addition, the central database may further store shared system setup information. Thus, the interface device may also retrieve and cache the shared system setup information for use in interfacing the at least one communications device with the respective account database. The at least one communications device may be one or more mobile wireless communications devices, and the accounts may be electronic mail (e-mail) accounts, for example.

A method aspect of the invention is for interfacing at least one communications device with a plurality of account databases each for storing information associated with different accounts. The method may include receiving an account access request from the at least one communications device for a desired account, and retrieving account location information associating the desired account with a respective account database from a central database. The method may further include interfacing the at least one communications device with the respective account database associated with the desired account based upon the retrieved account location information, and caching the account location information and using the cached account location information for subsequently interfacing the at least one communications device with the respective account database.

An interface device in accordance with the present invention may include a control module and a caching module, such as those described briefly above. A computer-readable medium in accordance with the present invention is also provided and may similarly include a control module and a caching module.

### BRIEF DESCRIPTION OF THE DRAWINGS

FIG. 1 is schematic block diagram of a communications system in accordance with the present invention.

FIG. 2 is schematic block diagram illustrating an embodiment of the communications system of FIG. 1 for accessing e-mail accounts.

FIG. 3 is flow diagram illustrating a distributed database access method in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in different embodiments.

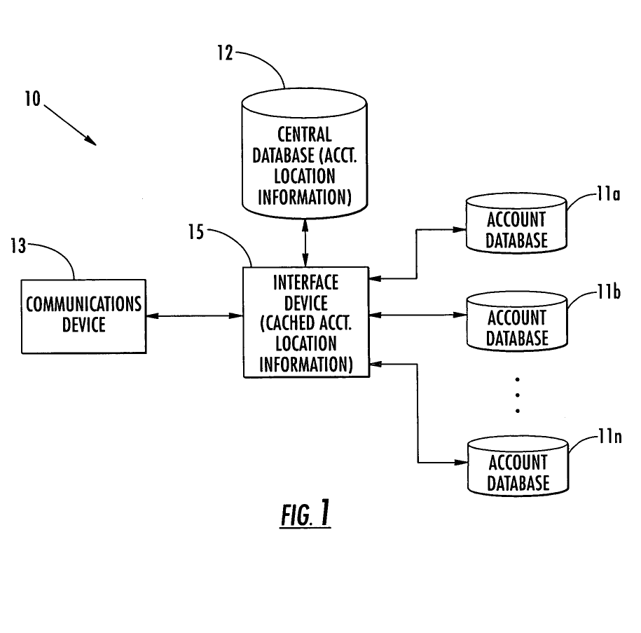

Referring initially to FIG. 1, a communications system 10 in accordance with the present invention illustratively includes a plurality of account databases 11a-11n. Each account database 11 stores information associated with different accounts to provide a distributed database architecture. By way of example, the accounts may be user e-mail accounts, and the information associated with each account may be user e-mails. The account databases 11a-11n may also be used for numerous other types of accounts and information for which databases are traditionally used, such as a corporate database system in which employees access information for different accounts or matters. Moreover, other types of accounts may include customer accounts for storing billing and/or payment information, bank accounts, etc.

The system 10 also illustratively includes a central database 12 for storing account location information associating each account with a respective account database 11. Thus, the central database 12 provides a central reference point for determining which account database 11 information for a desired account is located on. This information may be stored in the form of a lookup table, for example.

In addition to storing account location information, the central database 12 may optionally store any shared system setup information that would be used for accessing the account databases 11a-11n. Generally speaking, the shared system information would include any information that would otherwise have to be updated individually at each database 11 if not centrally stored, and thus cause access delays resulting in overall system performance degradation.

Generally speaking, the account information in the account databases 11a-11n is to be accessed by one or more communications devices 13. In the case of a corporate computer network communications system, for example, the communications device 13 may be a personal computer (PC) located at a user's desk. Of course, while only one communications device 13 is shown for clarity of illustration, it will be appreciated that any number of such communications devices may be used in accordance with the present invention.

To interface the communications device 13 with a desired account database 11, the system 10 also illustratively includes an interface device 15. The interface device 15 receives an account access request from the communications device 13 for a desired account. The form of the account access request will vary depending upon the type of account being accessed. For an e-mail account, a user or device identification (ID) may be provided, which the interface device 15 uses to determine which e-mail account is to be accessed. Various other types of account access requests will be appreciated by those skilled in the art based upon the type of account information being accessed.

Upon receiving an account access request, the interface device 15 retrieves account location information from the central database 12 for the desired account. The interface device 15 then interfaces the communications device 13 with the respective account database 11 associated with the desired account based upon the retrieved account location information.

In accordance with the invention, the interface device 15 also caches the retrieved account location information. As such, the interface device 15 may advantageously use the cached account location information for subsequently interfacing the communications device 13 with the respective account database. As such, the interface device 15 need not continually access the central database 12 for account location information if the communications device 13 makes fairly regular account access requests.

By caching the recently retrieved account location information, the interface device 15 need not repeatedly access the central database 12, which could cause significant bottlenecks and, thus, system performance degradation, as will be appreciated by those skilled in the art. Further, since cached account location information is readily available when subsequent access to the desired account is requested, the respective account database 11 may be accessed more quickly as well, further improving system performance.

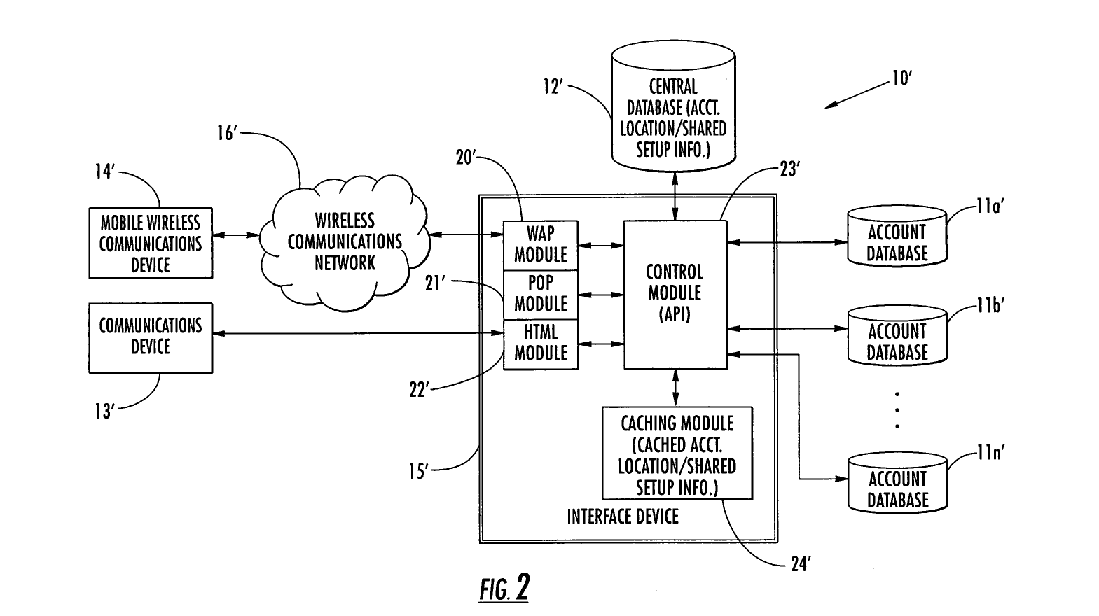

The communications system 10′ will now be further described with reference to an embodiment thereof for accessing e-mail accounts shown in FIG. 2. In the illustrated embodiment, the communications device 13′ may be a user's PC at his home, for example. The communications device 13′ may communicate with the interface device 15′ via a direct connection or the Internet, for example. Moreover, other communications devices, such as a mobile wireless communications device 14′, may communicate with the interface device 15′ via a wireless communications network 16′, for example, as will be appreciated by those skilled in the art. By way of example, the mobile wireless communications device 14′ may be a personal digital assistant (PDA), cellular telephone, or wireless enabled laptop computer.

Different types or brands of communications devices will typically use different operating protocols for accessing information such as e-mails and Web pages. By way of example, a desktop PC may use hypertext markup language (HTML) for sending and receiving e-mails, as it will typically have robust processing capabilities and a relatively high bandwidth connection to the interface device 15′. On the other hand, a PDA or cell phone will typically have more limited processing capabilities, and it will be subject to the bandwidth constraints of the wireless communications network 16′. As such, these types of devices may use the wireless access protocol (WAP), which provides more efficient access therefor.

Accordingly, since different operating protocols will be used to access the interface device 15′, the interface device advantageously includes respective protocol interface modules 20′-22′ for interfacing communications devices using respective protocols. That is, each protocol interface module 20′-22′ translates data between a particular operating protocol and a common protocol used by the interface device 15′. As shown, the module 20′ is a WAP module, the module 21′ is a post office protocol (POP) module, and the module 22′ is an HTML module. Of course, other protocol interface modules may be included for different operating protocols as well.

The interface device 15′ further illustratively includes a control module 23′ for communicating with the protocol interface modules 20′-22′ using the common protocol, and for accessing the central database 12′ and account databases 11a′-11n′, as described above. By way of example, the control module 23′ may be implemented as an application program interface (API), as will be appreciated by those skilled in the art. The interface device 15′ may also include a caching module 24′ for caching the retrieved account access information (and, optionally, system setup information) in a cache memory (not shown). Various caching approaches may be used, one of which is a rolling cache in which newly retrieved information displaces the oldest information in the cache once it reaches capacity. The particular cache size and caching approach used may vary from one implementation to another to provide desired performance, as will be appreciated by those skilled in the art.

In one embodiment, the interface device 15′ may be a server (e.g., a corporate or Internet service provider (ISP) server), and the modules 20′-24′ may be implemented as software modules thereon. It should also be noted that although they are shown as being separate for clarity of illustration, the various functions of the modules 20′-24′ could be implemented in a single software product or bundle, for example. It should also be noted that the interface device 15′ may be implemented on several servers or other devices, and the various modules 20′-24′ may be spread across the servers, as will be appreciated by those skilled in the art. Further, the interface device 15′ need not be on the same network as the account database 11a-11n (e.g., they may communicate over the Internet).

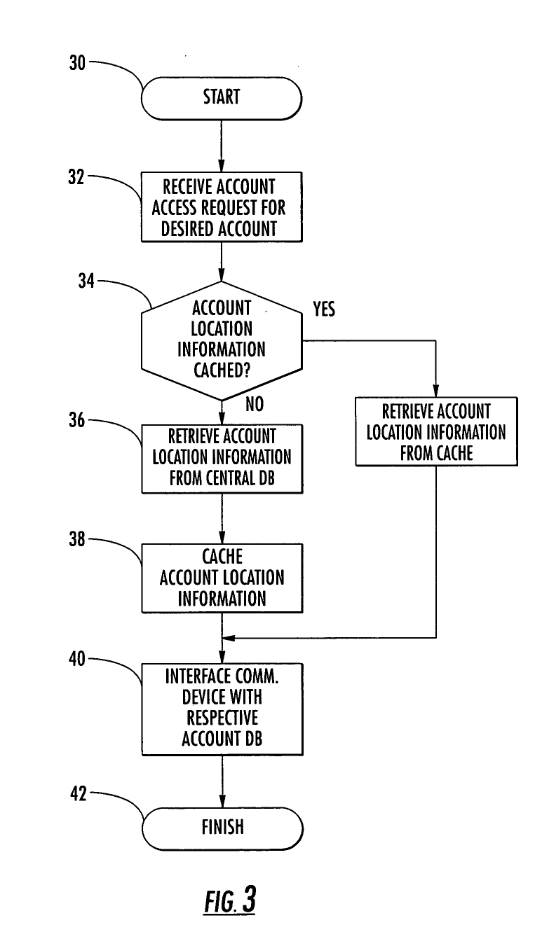

Turning now to FIG. 3, a method aspect of the invention for interfacing one or more communications devices 13 with a plurality of account databases 11a-11b each for storing information associated with different accounts is now described. Beginning at Block 30, an account access request is received from the communications device 13 for a desired account, at Block 32. If account location information associating the desired account with a respective account database 11 is not already cached, then this information is retrieved from the central database 12, at Blocks 34 and 36, and the retrieved account location information is cached, at Block 38, as previously described above.

Once the account location information is retrieved (whether from the central database 12 or from cache, at Block 35, if available), the method further includes interfacing the communications device 13 with the respective account database 11 associated with the desired account based upon the retrieved account location information, as described above, at Block 40, thus concluding the illustrated method (Block 42). Of course, it should be noted that the caching operation may take place after interfacing of the communications device 13 and the account database 11 in some embodiments. Moreover, system startup information may also be retrieved and cached, as noted above.

The invention also relates to a computer-readable medium having computer-executable instructions for interfacing at least one communications device 13′ with a plurality of account databases 11a′-11n′ each for storing information associated with different accounts. The computer-readable medium may include a control module 23′ for receiving an account access request from the at least one communications device 13′ for a desired account, retrieving account location information associating the desired account with respective-account databases 11a′-11n′ from a central database 12′, and interfacing the at least one communications device 13′ with the respective account databases 11a′-11n′ associated with the desired account based thereon. A caching module 24′ caches the account location information, and the control module 23′ uses the cached account location information for subsequently interfacing the at least one communications device 13′ with the respective account database, as previously described above.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A communications system comprising:
a plurality of account databases each for storing information associated with different accounts;
a central database for storing location information associating each account with a respective account database;
at least one communications device for accessing account information; and
an interface device for
receiving an account access request from said at least one communications device for a desired account,
retrieving account location information from said central database for the desired account, and interfacing said at least one communications device with said respective account database associated with the desired account based thereon, and
caching the account location information and using the cached account location information for subsequently interfacing said at least one communications device with said respective account database.

2. The communications system of claim 1 wherein said interface device comprises a caching module for caching the account location information.

3. The communications system of claim 1 wherein said at least one communications device has an operating protocol associated therewith, and wherein said interface device comprises at least one protocol interface module for communicating with said at least one communications device using the operating protocol.

4. The communications system of claim 3 wherein said at least one protocol interface module comprises at least one of a wireless access protocol (WAP) module, a post office protocol (POP) module, and a hypertext markup language (HTML) module.

5. The communications system of claim 3 wherein said interface device further comprises a control module for interfacing said at least one protocol interface module with said central and account databases.

6. The communications system of claim 1 wherein said central database further stores shared system setup information; and wherein said interface device also retrieves and caches the shared system setup information for use in interfacing said at least one communications device with said respective account database.

7. The communications system of claim 1 wherein said at least one communications device comprises at least one mobile wireless communications device.

8. The communications system of claim 1 wherein the accounts comprise electronic mail (e-mail) accounts.

9. An interface device for interfacing at least one communications device with a plurality of account databases each for storing information associated with different accounts, the interface device comprising:
a control module for receiving an account access request from the at least one communications device for a desired account, retrieving account location information associating the desired account with a respective account database from a central database, and interfacing the at least one communications device with the respective account database associated with the desired account based thereon; and
a caching module coupled to said control module for caching the account location information, said controller using the cached account location information for subsequently interfacing the at least one communications device with the respective account database.

10. The interface device of claim 9 wherein the at least one communications device has an operating protocol associated therewith; and further comprising at least one protocol interface module using the operating protocol for interfacing said control module with the at least one communications device.

11. The interface device of claim 10 wherein said at least one protocol interface module comprises at least one of a wireless access protocol (WAP) module, a post office protocol (POP) module, and a hypertext markup language (HTML) module.

12. The interface device of claim 9 wherein the central database further stores shared system setup information; wherein said control module also retrieves the shared system setup information for use in interfacing the at least one communications device with the respective account database, and wherein said caching module caches the retrieved shared system setup information.

13. The interface device of claim 9 wherein the accounts comprise electronic mail (e-mail) accounts.

14. A method for interfacing at least one communications device with a plurality of account databases each for storing information associated with different accounts, the method comprising:
receiving an account access request from the at least one communications device for a desired account;
retrieving account location information associating the desired account with a respective account database from a central database;
interfacing the at least one communications device with the respective account database associated with the desired account based upon the retrieved account location information; and
caching the account location information and using the cached account location information for subsequently interfacing the at least one communications device with the respective account database.

15. The method of claim 14 wherein retrieving further comprises retrieving shared system setup information from the central database, wherein interfacing comprises interfacing the at least one communications device with the respective account database also based upon the retrieved shared system setup information, and wherein caching further comprises caching the retrieved shared system setup information also for use in subsequently interfacing the at least one communications device with the respective account database.

16. The method of claim 14 wherein the accounts comprise electronic mail (e-mail) accounts.

17. A computer-readable medium having computer-executable instructions for interfacing at least one communications device with a plurality of account databases each for storing information associated with different accounts, the computer-readable medium comprising:
a control module for receiving an account access request from the at least one communications device for a desired account, retrieving account location information associating the desired account with a respective account database from a central database, and interfacing the at least one communications device with the respective account database associated with the desired account based thereon; and
a caching module for caching the account location information, said control module using the cached account location information for subsequently interfacing the at least one communications device with the respective account database.

18. The computer-readable medium of claim 17 wherein the at least one communications device has an operating protocol associated therewith; and further comprising at least one protocol interface module using the operating protocol for interfacing said control module with the at least one communications device.

19. The computer-readable medium of claim 18 wherein said at least one protocol interface module comprises at least one of a wireless access protocol (WAP) module, a post office protocol (POP) module, and a hypertext markup language (HTML) module.

20. The computer-readable medium of claim 17 wherein the central database further stores shared system setup information; wherein said control module also retrieves the shared system setup information for use in interfacing the at least one communications device with the respective account database, and wherein said caching module caches the retrieved shared system setup information.

21. The computer-readable medium of claim 17 wherein the accounts comprise electronic mail (e-mail) accounts.
